(19) United States
(12) Patent Application Publication
(10) Pub. No.: US 2008/0245084 A1
(43) Pub. Date: Oct. 9, 2008

(54) Apparatus and method for controlling stop operation of air conditioner

(75) Inventor: Kil Hong Song, Seoul (KR)

Correspondence Address: BACON & THOMAS, PLLC, 625 SLATERS LANE, FOURTH FLOOR, ALEXANDRIA, VA, 22314-1176, US

(73) Assignee: DAEWOO ELECTRONICS Corporation, Seoul (KR)

(21) Appl. No.: 12/000,947

(22) Filed: Dec. 19, 2007

(30) Foreign Application Priority Data
Apr. 3, 2007 (KR) 10-2007-0032824

(51) Int. Cl. G05D 23/19

(52) U.S. Cl. 62/158

(57) ABSTRACT

An apparatus for controlling a stop operation of an air conditioner includes: a compressor for compressing a refrigerant; an indoor heat exchanger for heat-exchanging between the refrigerant and indoor air; an indoor fan for blowing the heat-exchanged indoor air to indoors; and a controller. The controller controls, in response to an operation stop signal in operation, an operation of the indoor fan based on whether or not an operation of the compressor has completely stopped.

### FIELD OF THE INVENTION

The present invention relates to an operation control of an air conditioner; and, more particularly, to an apparatus and method for controlling a stop operation of an air conditioner, in which, after detecting an operation stop signal of the air conditioner in a heating operation mode, an open degree of an electronic expansion valve (EEV) decreases while a compressor is being stopped, a power supply interruption times of an outdoor fan and a four-way valve are changed, and an indoor fan stops when the temperature of an indoor heat exchanger reaches a specific value after the compressor stops.

### BACKGROUND OF THE INVENTION

An air conditioner is a device for maintaining a pleasant, comfortable indoor environment by running a cooling or heating operation to adjust air temperature in the indoor space.

In general, as illustrated in FIG. 1, a cooling operation of the air conditioner is performed in a cooling cycle, in which a compressor 10 compresses a refrigerant to high temperature and high pressure; a four-way valve 20 determines a refrigerant path according to an operation mode; an outdoor heat exchanger 30 carries out heat exchange between the high-temperature, high-pressure refrigerant compressed at the compressor 10 and an outdoor air to convert it to a low-temperature, high-pressure liquid state; an EEV 40 reduces the pressure of the liquid state refrigerant conveyed from the outdoor heat exchanger 30 to a low-temperature, low-pressure state; an indoor heat exchanger 50 gasifies the low-temperature, low-pressure refrigerant conveyed from the EEV 40 while flowing the refrigerant therein to perform heat exchange between the refrigerant and an indoor air; and a gas/liquid separator 60 filters the liquid state refrigerant from the refrigerant gasified in the indoor heat exchanger 50 to introduce it back into the compressor 10.

Further, installed at one side of the outdoor heat exchanger 30 is an outdoor fan 32 which intakes the outdoor air and blows it towards the outdoor heat exchanger 30, thereby enhancing heat exchange efficiency, and an indoor fan 52 is installed at one side of the indoor heat exchanger 50 to blow cold air having heat-exchanged at the indoor heat exchanger 50 to indoors.

Meanwhile, when the air conditioner is in a heating operation mode, the refrigerant path of the four-way valve 20 in the cooling cycle is changed, so that the refrigerant sequentially flows in the compressor 10, the four-way valve 20, the indoor heat exchanger 50, the EEV 40, the outdoor heat exchanger 30, and the gas/liquid separator 60.

FIGS. 2 and 3 show a conventional operation control procedure of an air conditioner and output signals of a stop operation, respectively.

When an air conditioner operation request signal is detected in step S10, it is checked in step S20 whether a cooling or heating operation is selected, and then a flow path of the four-way valve 20 is set according to the selected operation in step S30 or S31.

In step S40, the air conditioner is driven according to the flow path of the four-way valve 20 that has been set in the step S30 or S31, and continues the cooling or heating operation until an operation stop signal is detected in step S50. When the operation stop signal is detected in the step S50, the compressor 10 and the indoor fan 52 stop concurrently with the detection of the operation stop signal in step S60, and then the outdoor fan 32, the four-way valve 20, and the EEV 40 stop at the same time after a lapse of specific time from the stop of the compressor 10.

In the above-described conventional operation stop control method of an air conditioner, the compressor 10 in operation stops and the indoor fan 52 is turned off at the same time, i.e., at time t1 when the operation stop signal is inputted. Then, at time t2 after a lapse of specific time (about 1 minute) from the input of the operation stop signal at the time t1, the four-way valve 20, the outdoor fan 32, and the EEV 40 are all turned off at the same time. Therefore, an instantaneous current increase at the compressor 10 is generated, which makes unnecessary noise and vibration.

In other words, when the operation stop signal of the air conditioner is inputted, an operation frequency of the compressor 10 is controlled to decrease until the compressor 10 stops. At this time, even though the operation frequency of the compressor 10 decreases, current increases gradually. Thus, noise gets louder and the compressor 10 vibrates vigorously at the end of the stop operation.

Moreover, when the operation stop signal of the air conditioner is inputted, the operation of the air conditioner stops by decreasing the operation frequency of the compressor 10. However, the indoor fan 52 stops instantly, so that heat exchange is interrupted. Thus, a discharge pressure of the compressor 10 is raised to high pressure and current is increased. Due to the increase in current, a print circuit board, a control device, etc., experience an excessive current shock.

Also, when the four-way valve 20 and the EEV 40 are turned off concurrently, flow sound of the refrigerant may be generated at the time when the operation of the air conditioner stops and the heated refrigerant may remain in the indoor heat exchanger 50. Therefore, latent heat of the refrigerant causes the indoor heat exchanger itself to be deformed or discolored.

### SUMMARY OF THE INVENTION

In view of the above, the present invention provides an apparatus and method for controlling a stop operation of an air conditioner so that an indoor fan is maintained to operate at least until a compressor completely stops when the air conditioner stops its operation.

In accordance with a first aspect of the present invention, there is provided an apparatus for controlling a stop operation of an air conditioner, including:

a compressor for compressing a refrigerant;

an indoor heat exchanger for heat-exchanging between the refrigerant and indoor air;

an indoor fan for blowing the heat-exchanged indoor air to indoors; and

a controller for controlling, in response to an operation stop signal in operation, an operation of the indoor fan based on whether or not an operation of the compressor has completely stopped.

In accordance with a second aspect of the present invention, there is provided a method for controlling a stop operation of an air conditioner having a compressor, an outdoor fan, an indoor fan, a four-way valve and an electronic expansion valve, including:

decreasing, in response to an operation stop signal in operation, an open degree of the electronic expansion valve and an operation frequency of the compressor until an operation of the compressor stops, while maintaining the outdoor fan, the indoor fan, and the four-way valve to be in ON states;

turning off the indoor fan when the operation of the compressor has completely stopped; and

turning off the outdoor fan, the four-way valve, and the electronic expansion valve sequentially.

In accordance with a third aspect of the present invention, there is provided a method for controlling a stop operation of an air conditioner having a compressor, an outdoor fan, an indoor fan, a four-way valve and an electronic expansion valve, including:

decreasing, in response to an operation stop signal in operation, an open degree of the electronic expansion valve and an operation frequency of the compressor until an operation of the compressor stops, while maintaining the outdoor fan, the indoor fan, and the four-way valve to be in ON states;

controlling, when the operation of the compressor has completely stopped, an ON/OFF state of the indoor fan based on a temperature of an indoor heat exchanger for performing heat exchange between a refrigerant and indoor air; and

turning off the outdoor fan, the four-way valve, and the electronic expansion valve sequentially.

The present invention can prevent deformation of injection moldings of the indoor heat exchanger caused by the latent heat of refrigerant due to an interruption of heat exchange in response to the operation stop signal of the air conditioner in the heating operation.

Further, the present invention differentiates an operation stop time of the EEV from that of the compressor to prevent an instantaneous current increase due to the stop of the compressor, thereby preventing damages on a print circuit board and electronic components.

The present invention can also reduce the generation of vibration in the compressor at the time of complete stop thereof by preventing the current increase in the compressor.

Moreover, the present invention differentiates an OFF time of the four-way valve from that of the EEV, thereby preventing flow sound of the refrigerant from being generated when the air conditioner stops.

### BRIEF DESCRIPTION OF THE DRAWINGS

The objects and features of the present invention will become apparent from the following description of preferred embodiments, given in conjunction with the accompanying drawings, in which:

FIG. 1 illustrates a block diagram of the structure of a conventional air conditioner;

FIG. 2 illustrates a flowchart of a conventional control procedure of an air conditioner;

FIG. 3 illustrates a waveform diagram of conventional stop operation control output signals of an air conditioner;

FIG. 4 illustrates a block diagram of the configuration of an air conditioner stop operation control apparatus in accordance with the present invention;

FIG. 5 illustrates a flowchart of a method for controlling a stop operation of an air conditioner in accordance with an embodiment of the present invention;

FIG. 6 illustrates a waveform diagram of output signals during the stop operation control method of FIG. 5;

FIG. 7 illustrates a flowchart of a method for controlling a stop operation of an air conditioner in accordance with another embodiment of the present invention;

FIG. 8 illustrates a flowchart of a procedure for controlling the outdoor fan and the four-way valve of the air conditioner in the method of FIG. 7; and

FIG. 9 illustrates a waveform diagram of output signals during the stop operation control method of FIG. 7.

### DETAILED DESCRIPTION OF THE EMBODIMENT

Hereinafter, embodiments of the present invention will be described in detail with reference to the accompanying drawings. In the following description, the same reference numerals are denoted for the same components as the prior art.

FIG. 4 illustrates a block diagram of the configuration of an air conditioner stop operation control apparatus in accordance with the present invention.

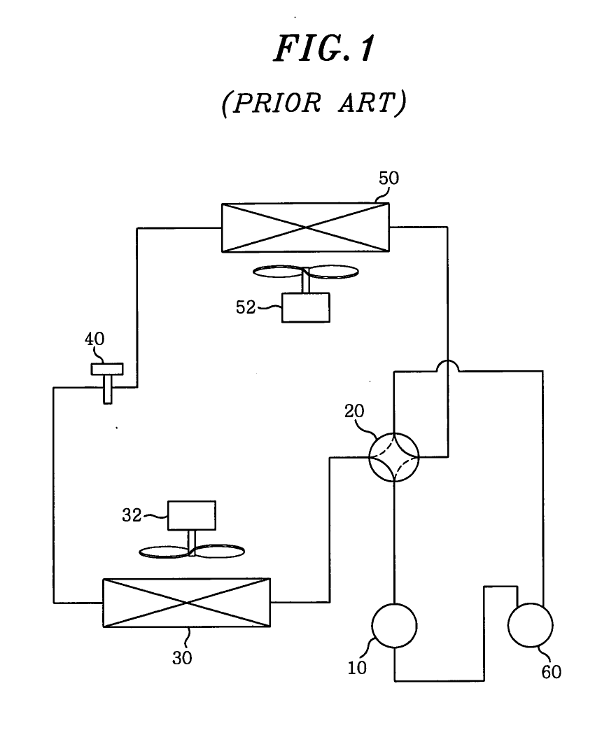

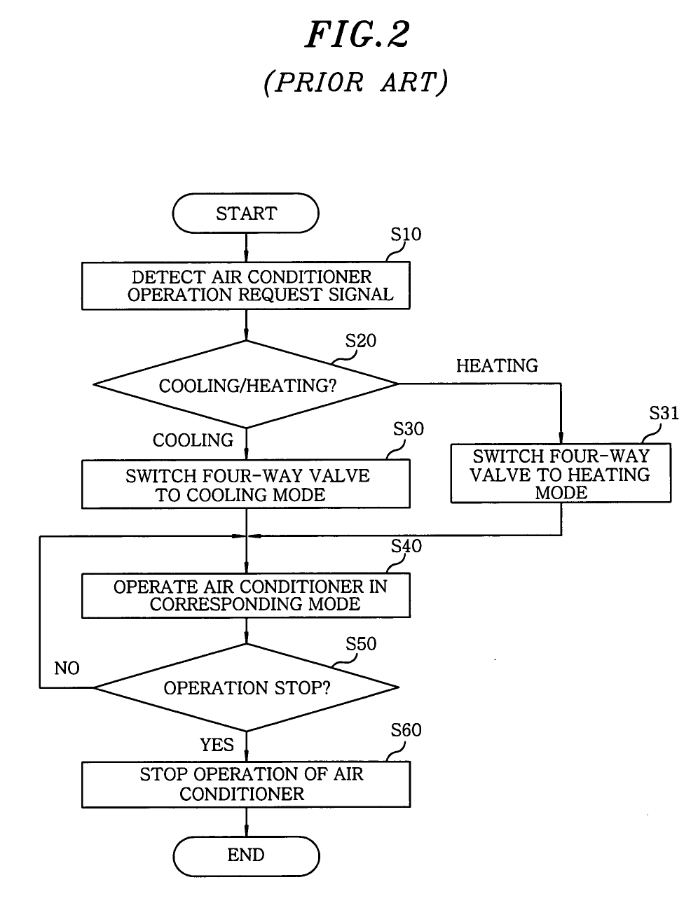

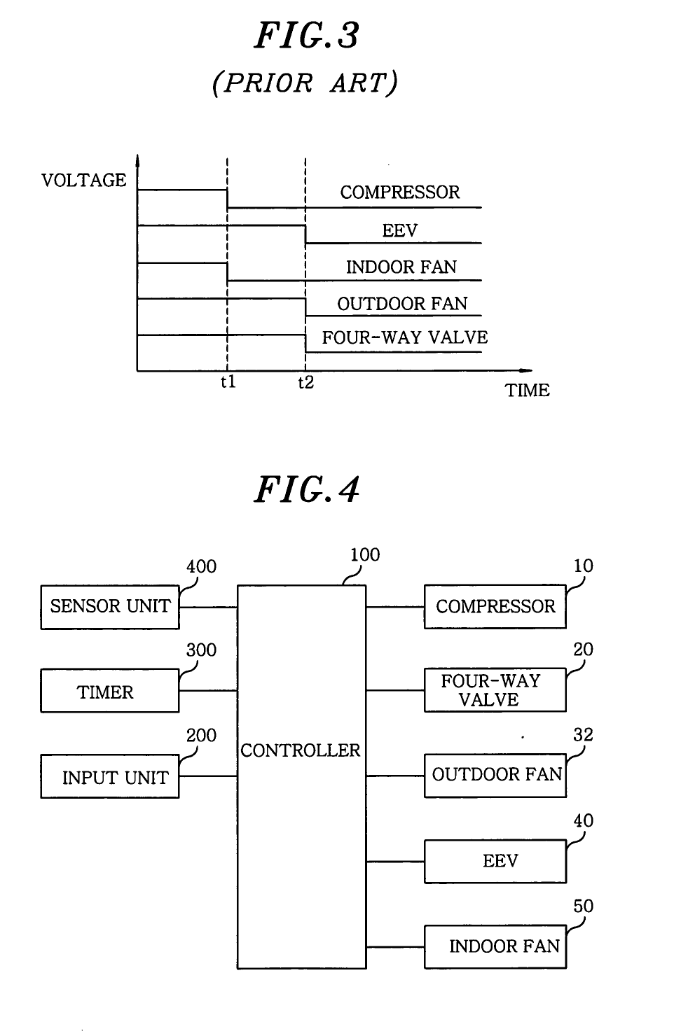

As shown in FIGS. 1 and 4, the air conditioner stop operation control apparatus according to the present invention includes: a compressor 10 for compressing a refrigerant; a four-way valve 20 for determining a refrigerant path according to an operation mode such as a cooling or heating operation mode; an outdoor fan 32 for blowing outdoor air to an outdoor heat exchanger 30 to perform a heat exchange between the outdoor air and the refrigerant; an EEV 40 for reducing pressure of the refrigerant; an indoor fan 52 for blowing indoor air having heat-exchanged with the refrigerant at an indoor heat exchanger 50; and a controller 100 for generating, when an operation stop signal is inputted to the air conditioner in operation, an ON/OFF operation signal of the indoor fan 52 based on whether the operation of the compressor 10 has completely stopped.

The controller 100 serves to control the operation of the air conditioner. That is, it detects a start signal of a cooling or a heating operation and an operation stop signal given from a user through an input unit 200, and controls the air conditioner to run in a corresponding operation mode according to the detected input signal.

More specifically, when the operation start signal of one of the cooling and the heating operation is inputted, the controller 100 determines the refrigerant path of the four-way valve 20, and turns on the compressor 10, the outdoor fan 32, and the indoor fan 52. Preferably, the operation start signal is the heating operation start signal.

When the operation stop signal is detected through the input unit 200 after the air conditioner has operated for a certain amount of time, the controller 100 decreases an operation frequency of the compressor 10 (e.g., gradually decreases from 60 Hz to 0 Hz) to stop the compressor 10, and provides an OFF signal to the indoor fan 52 when the operation frequency of the compressor 10 becomes 0 Hz (complete stop).

If the operation frequency of the compressor 10 is not 0 Hz, the controller 100 provides an ON signal to the indoor fan 52 to maintain the indoor fan 52 in the ON state.

The stop operation control apparatus of an air conditioner in accordance with the present invention further includes a timer 300 for detecting an elapsed time since the compressor 10 has stopped and providing the elapsed time to the controller 100. Then, the controller 100 sequentially turns off the outdoor fan 32, the four-way valve 20, and the EEV 40, based on the elapsed time detected by the timer 300.

That is, when the elapsed time, detected by the timer 300, since the compressor 10 has stopped exceeds a reference time (e.g., about 1 minute) of outdoor fan turn-off determination, the controller 100 outputs an OFF signal to the outdoor fan 32. Similarly, when the elapsed time, detected by the timer 300, since the compressor 10 has stopped exceeds a reference time (e.g., about one and a half minutes) of the four-way valve turn-off determination, the controller 100 outputs an OFF signal to the four-way valve 20. When all of the four-way valve 20, the outdoor fan 32, the indoor fan 52 have stopped, the controller 100 outputs an OFF signal to the EEV 40.

The stop operation control apparatus of an air conditioner in accordance with the present invention further includes a sensor unit 400, installed at one side of the indoor heat exchanger 50, for detecting temperature of the indoor heat exchanger 50.

The temperature detected by the sensor unit 400 is provided to the controller 100, and the controller 100 outputs an ON/OFF signal for the indoor fan 52 based on the temperature detected by the sensor unit 400.

To be specific, if the temperature detected by the sensor unit 400 exceeds a reference temperature of indoor fan turn-off determination, the controller 100 outputs the ON signal to the indoor fan 52. Meanwhile, if the temperature detected by the sensor unit 400 does not exceed the reference temperature of indoor fan turn-off determination, the controller 100 outputs the OFF signal to the indoor fan 52.

Now, embodiments of a method for controlling a stop operation of an air conditioner in accordance with the present invention will be described in detail.

### Embodiment 1

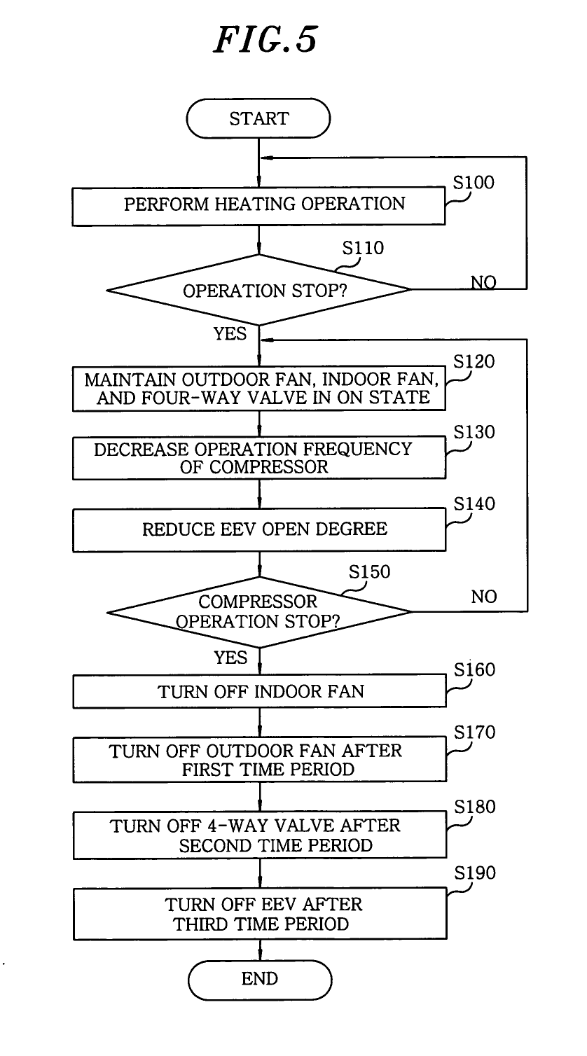

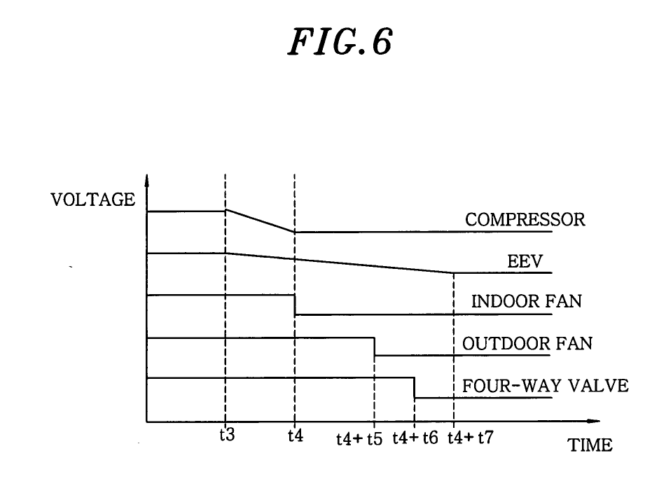

FIG. 5 illustrates a flowchart of a method for controlling a stop operation of an air conditioner in accordance with an embodiment of the present invention, and FIG. 6 illustrates a waveform diagram of output signals during the stop operation control method of FIG. 5.

Referring to FIGS. 4 to 6, the controller 100 determines whether an air conditioner operation stop signal is inputted through the input unit 200 of the air conditioner operating in a heating mode in steps S100 and S110. When the operation stop signal is inputted (at time t3, see FIG. 6), the controller 100 outputs an ON signal to the outdoor fan 32, the indoor fan 52, and the four-way valve 20 to maintain them to be in ON states in step S120; outputs a control signal for decreasing the operation frequency of the compressor 10 to stop the operation thereof in step S130; and outputs a control signal for reducing the open degree of the EEV 40 to adjust refrigerant amount according to the decrease in the operation frequency of the compressor 10 in step S140.

The controller 100 continues decreasing the operation frequency of the compressor 10 until it reaches 0 Hz, and determines whether or not the compressor 10 has completely stopped in step S150.

If it is determined that the operation of the compressor 10 has not stopped completely in the step S150, the controller 100 repeats the steps S120 to S140. On the other hand, if it is determined that the compressor 10 has completely stopped, the controller 100 outputs an OFF signal to the indoor fan 52 (at time t4, see FIG. 6) to stop the operation of the indoor fan 52 in step S160.

After that, if the timer 300 indicates that an elapsed time since the compressor 10 has stopped is t5 (see FIG. 6), the controller 100 outputs an OFF signal to the outdoor fan 32 to stop it in step S170. Further, if the timer 300 indicates that the elapsed time since the compressor 10 has stopped is t6 (see FIG. 6), the controller 100 outputs an OFF signal to the four-way valve 20 to stop it in step S180. Furthermore, if all of the four-way valve 20, the outdoor fan 32, and the indoor fan 52 have stopped or if the timer 300 indicates that the elapsed time since the compressor 10 has stopped is t7 (see FIG. 6), the controller 100 outputs an OFF signal to the EEV 40 to stop it in step S190.

Therefore, it is possible to prevent an interruption in heat exchange due to the operation stop of the indoor fan 52 and deterioration of injection moldings of the indoor heat exchanger 50.

### Embodiment II

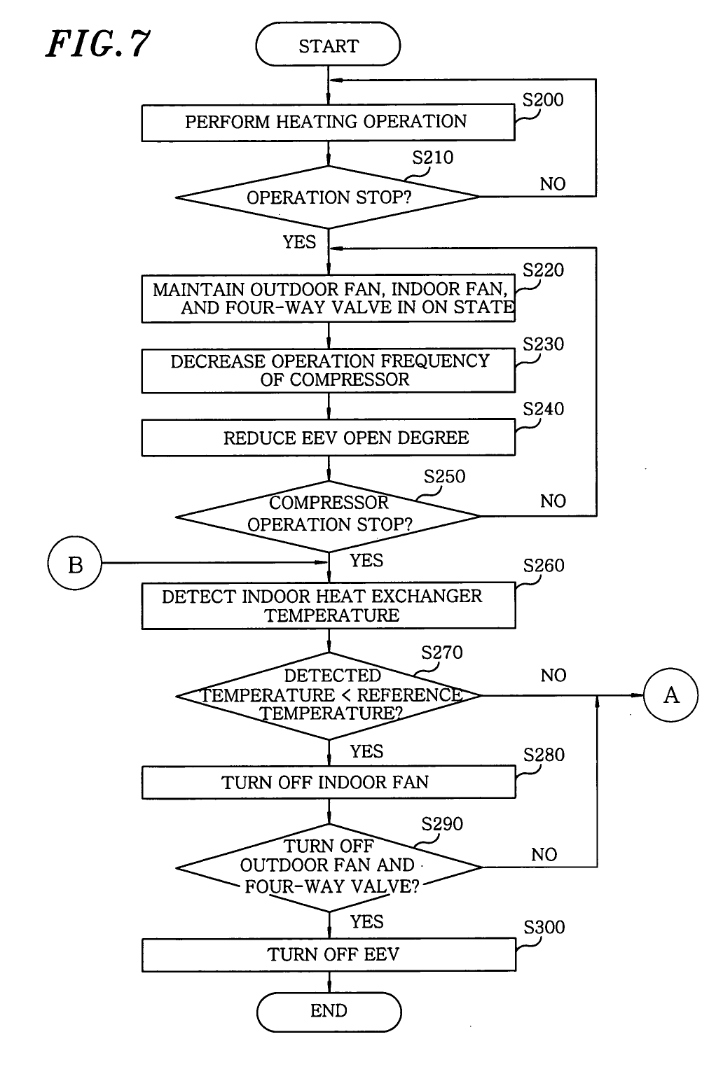

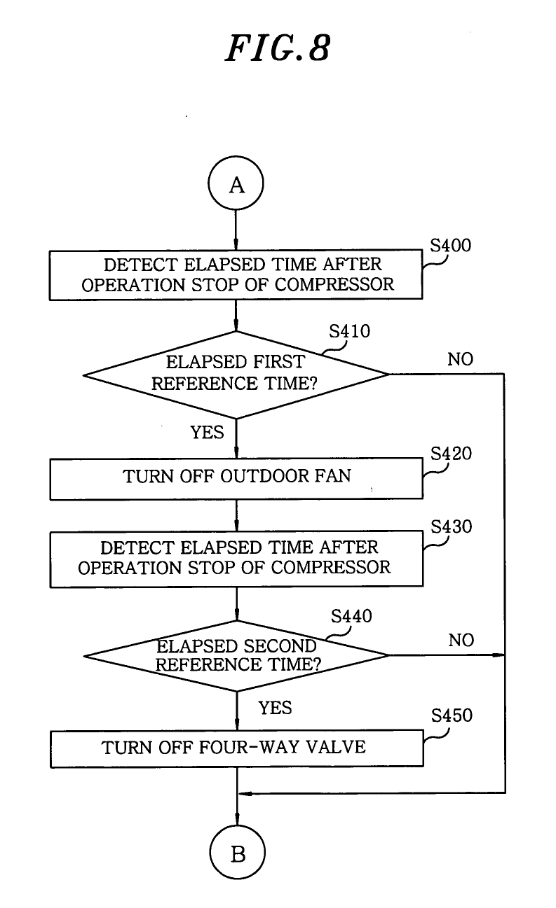

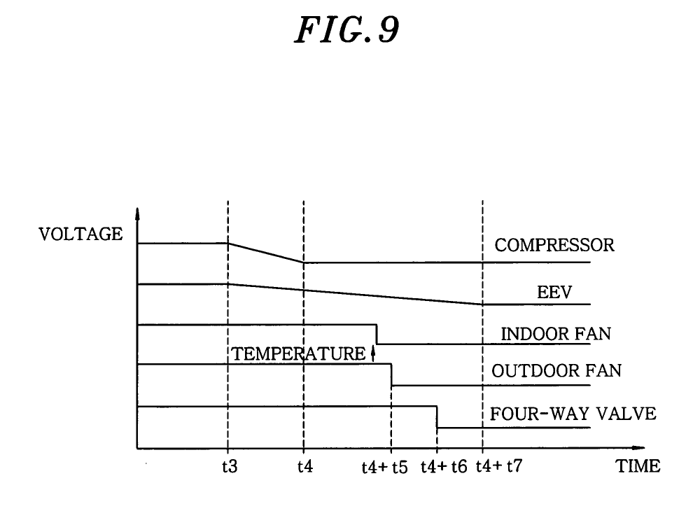

FIG. 7 illustrates a flowchart of a method for controlling a stop operation of an air conditioner in accordance with another embodiment of the present invention; FIG. 8 illustrates a flowchart of a procedure for controlling the outdoor fan and the four-way valve of the air conditioner in the method of FIG. 7; and FIG. 9 illustrates a waveform diagram of output signals during the stop operation control method of FIG. 7.

Referring to FIGS. 4 and 7 to 9, the controller 100 determines whether an air conditioner operation stop signal is inputted through the input unit 200 of the air conditioner operating in a heating mode in steps S200 and S210. When the operation stop signal is inputted (at time t3, see FIG. 9), the controller 100 outputs an ON signal to the outdoor fan 32, the indoor fan 52, and the four-way valve 20 to maintain them to be in ON states in step S220; outputs a control signal for decreasing the operation frequency of the compressor 10 to stop the operation thereof in step S230; and outputs a control signal for reducing the open degree of the EEV 40 to adjust refrigerant amount according to the decrease in the operation frequency of the compressor 10 in step S240.

The controller 100 continues decreasing the operation frequency of the compressor 10 until it reaches 0 Hz, and determines whether or not the compressor 10 has completely stopped in step S250.

If it is determined that the operation of the compressor 10 has not stopped completely in the step S250, the controller 100 repeats the steps S220 to S240. On the other hand, if it is determined that the compressor 10 has completely stopped (at time t4, see FIG. 9), the controller 100 detects temperature of the indoor heat exchanger 50 using the sensor unit 400 in step S260 and compares it with a preset reference temperature of indoor fan turn-off determination in step S270.

The reference temperature of indoor fan turn-off determination is set to 49° C. or below so as to prevent deformation of injection moldings (e.g., indoor case, flap, etc.) due to the latent heat.

As a comparison result of the step S270, if the detected temperature is lower than the reference temperature, the controller 100 outputs an OFF signal to the indoor fan 52 to stop the operation of the indoor fan 52 in step S280.

When the indoor fan 52 has stopped, the controller 100 determines whether the outdoor fan 32 and the four-way valve 20 have stopped in step S290. If it is determined that both the four-way valve 20 and the outdoor fan 32 have stopped, the controller 100 outputs an OFF signal to the EEV 40 to stop the operation of the EEV 40 in step S300 (at time t4+t7, see FIG. 9).

Meanwhile, as a comparison result of the step S270, if the detected temperature is higher than the reference temperature, the controller 100 outputs an ON signal to the indoor fan 52, and detects an elapsed time since the compressor 10 has stopped by using the timer 300 in step S400.

In step S410, the controller 100 compares the time detected in the step S400 with a first reference time t5 (see FIG. 9) of outdoor fan turn-off determination. As a comparison result of the step S410, if the detected time is less than the first reference time t5, the controller 100 performs the step S260 again while still outputting the ON signal to the outdoor fan 32.

As a comparison result of the step S410, if the detected time reached the first reference time t5, the controller 100 outputs an OFF signal to the outdoor fan 32 to stop its operation in step S420.

After performing the step S420, the controller 100 detects an elapsed time since the compressor has stopped in step S430, and compares the detected time with a second reference time t6 (see FIG. 9) of four-way valve turn-off determination in step S440.

As a comparison result of the step S440, if the detected time is less than the second reference time t6, the controller 100 performs the step S260 again while still outputting the ON signal to the four-way valve 20.

As a comparison result of the step S440, if the detected time reached the second reference time t6, the controller 100 outputs an OFF signal to the four-way valve 20 to stop its operation in step S450.

Meanwhile, after performing the step S420, the controller 100 may perform the step S260 for detecting temperature of the indoor heat exchanger 50, and compare the detected temperature with the reference temperature to determine whether to stop the indoor fan 52 or not.

While the invention has been shown and described with respect to the embodiments, it will be understood by those skilled in the art that various changes and modification may be made without departing from the scope of the invention as defined in the following claims.

What is claimed is:

1. An apparatus for controlling a stop operation of an air conditioner, comprising:
a compressor for compressing a refrigerant;
an indoor heat exchanger for heat-exchanging between the refrigerant and indoor air;
an indoor fan for blowing the heat-exchanged indoor air to indoors; and
a controller for controlling, in response to an operation stop signal in operation, an operation of the indoor fan based on whether or not an operation of the compressor has completely stopped.

2. The apparatus of claim 1, wherein the controller outputs an OFF signal to the indoor fan when the operation of the compressor has completely stopped, and outputs an ON signal to the indoor fan when the compressor is in operation.

3. The apparatus of claim 1, further comprising a sensor unit for detecting temperature of the indoor heat exchanger, wherein the controller controls the operation of the indoor fan based on the temperature detected by using the sensor unit.

4. The apparatus of claim 3, wherein, if the detected temperature by the sensor unit exceeds a reference temperature of indoor fan turn-off determination, the controller outputs the ON signal to the indoor fan, whereas, if the detected temperature does not exceed the reference temperature, the controller outputs the OFF signal to the indoor fan.

5. The apparatus of claim 1, further comprising:
a four-way valve for determining a refrigerant path;
an outdoor heat exchanger for heat-exchanging between outdoor air and the refrigerant;
an outdoor fan for blowing the outdoor air to the outdoor heat exchanger;
an electronic expansion valve for reducing pressure of the refrigerant; and
a timer for detecting an elapsed time since the operation of the compressor has completely stopped,
wherein the controller sequentially turns off the outdoor fan, the four-way valve, and the electronic expansion valve based on the elapsed time.

6. The apparatus of claim 2, further comprising:
a four-way valve for determining a refrigerant path;
an outdoor heat exchanger for heat-exchanging between outdoor air and the refrigerant;
an outdoor fan for blowing the outdoor air to the outdoor heat exchanger;
an electronic expansion valve for reducing pressure of the refrigerant; and
a timer for detecting an elapsed time since the operation of the compressor has completely stopped,
wherein the controller sequentially turns off the outdoor fan, the four-way valve, and the electronic expansion valve based on the elapsed time.

7. The apparatus of claim 3, further comprising:
a four-way valve for determining a refrigerant path;
an outdoor heat exchanger for heat-exchanging between outdoor air and the refrigerant;
an outdoor fan for blowing the outdoor air to the outdoor heat exchanger;
an electronic expansion valve for reducing pressure of the refrigerant; and
a timer for detecting an elapsed time since the operation of the compressor has completely stopped,
wherein the controller sequentially turns off the outdoor fan, the four-way valve, and the electronic expansion valve based on the elapsed time.

8. The apparatus of claim 4, further comprising:
a four-way valve for determining a refrigerant path;
an outdoor heat exchanger for heat-exchanging between outdoor air and the refrigerant;
an outdoor fan for blowing the outdoor air to the outdoor heat exchanger;
an electronic expansion valve for reducing pressure of the refrigerant; and
a timer for detecting an elapsed time since the operation of the compressor has completely stopped,
wherein the controller sequentially turns off the outdoor fan, the four-way valve, and the electronic expansion valve based on the elapsed time.

9. The apparatus of claim 5, wherein the controller outputs OFF signals to the outdoor fan if the elapsed time exceeds a reference time of outdoor fan turn-off determination; to the four-way valve if the elapsed time exceeds a reference time of four-way valve turn-off determination; and to the electronic expansion valve if all of the four-way valve, the outdoor fan, and the indoor fan have stopped.

10. The apparatus of claim 6, wherein the controller outputs OFF signals to the outdoor fan if the elapsed time exceeds a reference time of outdoor fan turn-off determination; to the four-way valve if the elapsed time exceeds a reference time of four-way valve turn-off determination; and to the electronic expansion valve if all of the four-way valve, the outdoor fan, and the indoor fan have stopped.

11. The apparatus of claim 7, wherein the controller outputs OFF signals to the outdoor fan if the elapsed time exceeds a reference time of outdoor fan turn-off determination; to the four-way valve if the elapsed time exceeds a reference time of four-way valve turn-off determination; and to the electronic expansion valve if all of the four-way valve, the outdoor fan, and the indoor fan have stopped.

12. The apparatus of claim 8, wherein the controller outputs OFF signals to the outdoor fan if the elapsed time exceeds a reference time of outdoor fan turn-off determination; to the four-way valve if the elapsed time exceeds a reference time of four-way valve turn-off determination; and to the electronic expansion valve if all of the four-way valve, the outdoor fan, and the indoor fan have stopped.

13. A method for controlling a stop operation of an air conditioner having a compressor, an outdoor fan, an indoor fan, a four-way valve and an electronic expansion valve, comprising:
decreasing, in response to an operation stop signal in operation, an open degree of the electronic expansion valve and an operation frequency of the compressor until an operation of the compressor stops, while maintaining the outdoor fan, the indoor fan, and the four-way valve to be in ON states;
turning off the indoor fan when the operation of the compressor has completely stopped; and
turning off the outdoor fan, the four-way valve, and the electronic expansion valve sequentially.

14. The method of claim 13, wherein turning off the outdoor fan, the four-way valve, and the electronic expansion valve sequentially includes:
outputting an OFF signal to the outdoor fan when an elapsed time since the compressor has stopped reaches a first specific time;
outputting an OFF signal to the four-way valve when the elapsed time reaches a second specific time longer than the first specific time; and
outputting an OFF signal to the electronic expansion valve when the elapsed time reaches a third specific time longer than the second specific time.

15. A method for controlling a stop operation of an air conditioner having a compressor, an outdoor fan, an indoor fan, a four-way valve and an electronic expansion valve, comprising:
decreasing, in response to an operation stop signal in operation, an open degree of the electronic expansion valve and an operation frequency of the compressor until an operation of the compressor stops, while maintaining the outdoor fan, the indoor fan, and the four-way valve to be in ON states;
controlling, when the operation of the compressor has completely stopped, an ON/OFF state of the indoor fan based on a temperature of an indoor heat exchanger for performing heat exchange between a refrigerant and indoor air; and
turning off the outdoor fan, the four-way valve, and the electronic expansion valve sequentially.

16. The method of claim 15, wherein controlling the ON/OFF state of the indoor fan includes:
detecting the temperature of the indoor heat exchanger; and
maintaining the indoor fan to be in the ON state if the detected temperature is higher than a reference temperature of indoor fan turn-off determination, and turning off the indoor fan if the detected temperature is lower than the reference temperature.

17. The method of claim 15, wherein turning off the outdoor fan, the four-way valve, and the electronic expansion valve sequentially includes:
turning off the outdoor fan when an elapsed time since the compressor has stopped reaches a first specific time;
turning off the four-way valve when the elapsed time reaches a second specific time longer than the first specific time; and
turning off the electronic expansion valve after stopping the indoor fan, the outdoor fan, and the four-way valve.
